(19) United States
(12) Patent Application Publication
(10) Pub. No.: US 2022/0267131 A1
(43) Pub. Date: Aug. 25, 2022

(54) SMART WAREHOUSE SAFETY MECHANISMS

(71) Applicant: Phantom Auto Inc., Mountain View, CA (US)

(72) Inventors: Shay Magzimof, Palo Alto, CA (US); David Parunakian, Moscow (RU); Ohad Dvir, Mazkeret Batia (IL); Brett B. Rogers, West Point, UT (US)

(21) Appl. No.: 17/675,812

(22) Filed: Feb. 18, 2022

Related U.S. Application Data
(60) Provisional application No. 63/152,818, filed on Feb. 23, 2021.

(51) Int. Cl. B66F 17/00; B66F 9/06; G05D 1/00; G05D 1/02

(52) U.S. Cl. CPC B66F 17/003; B66F 9/063; G05D 1/0038; G05D 1/0212; G05D 2201/0216

(57) ABSTRACT

A remote operation system provides support to utility vehicles (such as forklifts). The remote operation system controls a forklift to safely perform an emergency stop when the remote operation system determines that safe operation of the forklift is difficult. To perform an emergency stop of a forklift, the system monitors the kinematics of the forklift based at least in part on the mass distribution of a load being carried by the forklift and an elevation of the fork of the forklift. Moreover, in response to determining to execute an emergency stop, the system determines a deceleration limit for the forklift based on the kinematics of the forklift, and activates the brakes of the forklift based on the determined deceleration limit.

### CROSS REFERENCE TO RELATED APPLICATIONS

This application claims the benefit of U.S. Provisional Application No. 63/152,818, filed Feb. 23, 2021, which is incorporated by reference in its entirety.

### BACKGROUND

### Field of the Invention

This disclosure relates generally to connected vehicles, and more specifically to safety mechanisms for remotely operated cargo and utility vehicles in warehouses or other industrial and logistical settings.

### Description of the Related Art

The ongoing explosion of computing and network technologies has a profound impact on all fields of human endeavor. Among other effects, diminishing sizes and power requirements of computers as well as advances in cellular communications and rapidly falling costs have created vast opportunities for optimizing transportation and the logistics industry. While the goal of building fully autonomous fleets of passenger vehicles and taxicabs occupies public attention, safety considerations dictate that vehicles should also have teleoperation capacity to be controlled by a remote driver in case the machine intelligence operating the autonomous vehicle is incapable of proceeding safely. Teleoperation may also be used with industrial applications, reducing the potential for human injuries and improving the total efficiency of industrial vehicle operators by merging with custom information systems and augmented reality displays. However, any implementation of an industrial vehicle teleoperation system should acknowledge and treat a number of special scenarios in order to enable safe operation.

### SUMMARY

A remote operation system provides support to utility vehicles (such as forklifts). The remote operation system controls a forklift to safely perform an emergency stop when the remote operation system determines that safe operation of the forklift is difficult. To perform an emergency stop of a forklift, the remote operation system monitors the kinematics of the forklift based at least in part on the mass distribution of a load being carried by the forklift and an elevation of the fork of the forklift. Moreover, in response to determining to execute an emergency stop, the remote operation system determines a deceleration limit for the forklift based on the kinematics of the forklift, and activates the brakes of the forklift based on the determined deceleration limit.

In some embodiments, the remote operation system performs an emergency stop in response to receiving an emergency stop message from a remote operator of the forklift. Moreover, the remote operation system may perform an emergency stop in response to determining that a latency of one or more video feeds used for controlling the operation of the forklift exceeds a threshold latency. Additionally, the remote operation system may perform an emergency stop in response to determining that a desynchronization interval between pairs of video feeds used for controlling the operation of the forklift exceeds a desynchronization threshold. In yet another example, the remote operation system may perform an emergency stop in response to failing to receive a threshold number of keep-alive signals.

In some embodiments, the remote operation system periodically solves a set of kinematic equations based on the mass distribution of the load being carried by the forklift and the elevation of the fork at the time the set of kinematic equations are being solved. In response to determining to execute an emergency stop, the remote operation system retrieves the latest solution of the set of kinematics equations and determines the deceleration limit based on the retrieved solution. In some embodiments, the mass distribution of the load being carried by the forklift is determined using at least one of a set of load sensors embedded in the fork for the forklift, and a set of pressure sensors embedded in a set of wheels of the forklift.

Moreover, the remote operation system may analyze data captured by one or more sensors embedded in the forklift, and determines whether an object is within a location determined based on the location of the forklift and/or the elevation of the fork of the forklift. If the remote operation system determines that an object is within the location, the remote operation system triggers a collision warning event.

### BRIEF DESCRIPTION OF THE DRAWINGS

FIG. 1 is an illustration of a smart warehouse layout, in accordance with one or more embodiments.

FIG. 2A is an illustration of a forklift remote operation system, in accordance with one or more embodiments.

FIG. 2B illustrates example control modules of the remote forklift operation system, in accordance with one or more embodiments.

FIG. 3A is an illustration of various forklift types, in accordance with one or more embodiments.

FIG. 3B is an illustration of various transportation modes, in accordance with one or more embodiments.

FIG. 4 is an illustration of standard and tank steering methods, in accordance with one or more embodiments.

FIG. 5 is an illustration of a forklift operational protocol, in accordance with one or more embodiments.

FIG. 6 is an illustration of mixed reality visual display system indicators, in accordance with one or more embodiments.

FIG. 7 is an illustration of a camera field-of-view indicator, in accordance with one or more embodiments.

FIG. 8 illustrates a flow diagram for controlling a forklift to load a pallet onto the fork of the forklift, according to one or more embodiments.

FIG. 9 illustrates a flow diagram for controlling an emergency stop of a forklift, according to one or more embodiments.

### DETAILED DESCRIPTION

Recent advances in autonomous driving technology, wireless communications and networked multimedia tools have enabled proliferation of Internet of Things products and digital transformation of multiple industries. Increasing reliability of networked application stacks and cloud computing has made it practical to adopt this approach for applications with high safety requirements, such as teleoperation of road or industrial vehicles.

### Configuration Overview

A remote forklift operation system includes a forklift, which includes the base vehicle, a drive-by-wire system, an onboard computing system, a sensor suite and a network interface, and an operator console. The operator console in turn includes a human interface device or a plurality thereof, a visual display system, a computer and a network interface. The network interfaces of the forklift and the operator console enable communication between the forklift and an operator console over private or public digital networks.

In an embodiment, the system additionally includes an augmented reality layer (ARL) displayed on the operator console to enable the operator to perceive in visual, graphical, or numerical form, information relevant to remote operation safety.

In an embodiment, the system additionally includes a hazard estimation module enabling the operator to assess the danger level of a maneuver based on both external and internal variables such as wireless connectivity status, activity of other vehicles and personnel in the warehouse and the skill level of the operator.

In an embodiment, the system additionally includes a ramp traversal assistance module enabling the operator to safely operate the forklift on inclined surfaces.

In an embodiment, the system additionally includes an audiovisual guidance module, enabling the operator to efficiently navigate the warehouse.

In an embodiment, the system additionally includes a lateral positioning guidance module, enabling the operator to effectively position the forklift against the entrance into a cargo hold or a rack slot.

In an embodiment, the system additionally includes a pallet slot illumination module based on ranging sensor, laser guideline or non-coherent lighting implements.

In an embodiment, the system additionally includes a fork contact and position detection module, enabling the operator to determine whether the fork of a forklift is in contact with any part of the pallet and the depth at which they are inserted into the pallet openings.

In an embodiment, the system additionally includes an obstacle detection module to identify objects and material in potentially dangerous locations around the forklift body and the fork, or beneath or above fork, as well as determine the distance to them.

In an embodiment, the system additionally includes an emergency stop module, in turn comprising one or more of keep-alive signal monitor, data latency monitor, video latency and quality monitor, network monitor, a manual trigger device.

In a further embodiment, the system additionally includes a collision avoidance monitor integrated with the emergency stop module and restricts actions which may result in a collision with personnel, vehicles, or material. In some embodiments, the system includes a kinematic solution module which enables computation of potentially hazardous emergency stop maneuvers and their restriction.

In an embodiment, the system additionally includes bidirectional driving support, enabling the operator to switch between perceived front and rear of the forklift. In a further embodiment, the system additionally includes a current heading indicator integrated with the forklift, enabling the on-site personnel to accurately assess the sector of the forklift surroundings which is currently in the focus of the operator's attention.

In an embodiment, the system additionally includes a high dynamic range video system, enabling the operator station or the onboard computer to remove or to compensate ill effects originating from moving between brightly and dimly lit areas.

In an embodiment, the system additionally includes a wireless network connectivity model based on access point locations, positions and attitudes of vehicles and material in the warehouse, or other parameters.

### System Architecture

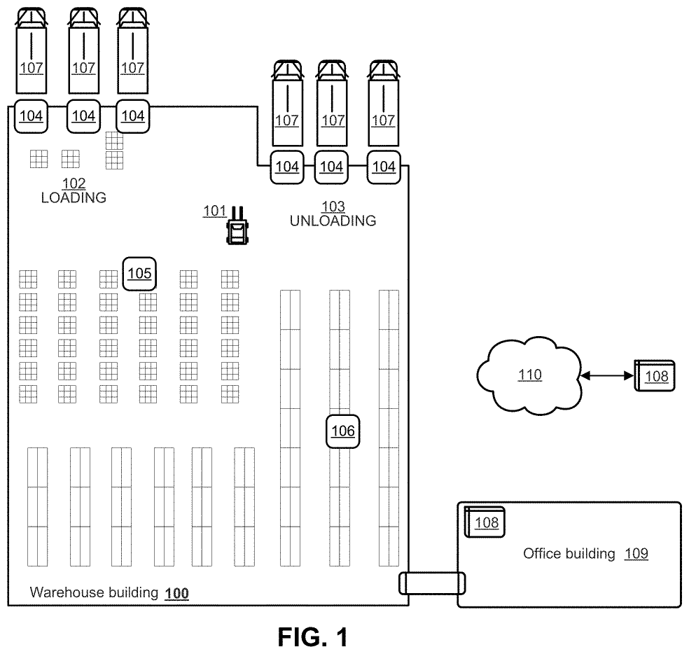

FIG. 1 illustrates an example setting of a remote operation of forklifts 101 (or other utility vehicles) located in a warehouse facility 100, according to one or more embodiments. In some embodiments, the forklifts 101 or other utility vehicles located in the warehouse facility 100 are operated by human agents from operator stations 108 located in a proximal office 109 or in a distant networked location 110. A warehouse facility 100 may have one or more loading areas 102 and drop off areas 103 adjacent to loading docks 104, picking areas 105, and blocks of pallet racks 106. To perform horizontal or vertical transportation of pallets between racks 106 as well as loading and unloading of cargo trucks 107, multiple types of forklifts 101 can be utilized. However, the task of remotely operating a forklift 101 and performing its functions safely, reliably, and efficiently requires solving a number of challenges uncommon for remote operation of road or sidewalk vehicles.

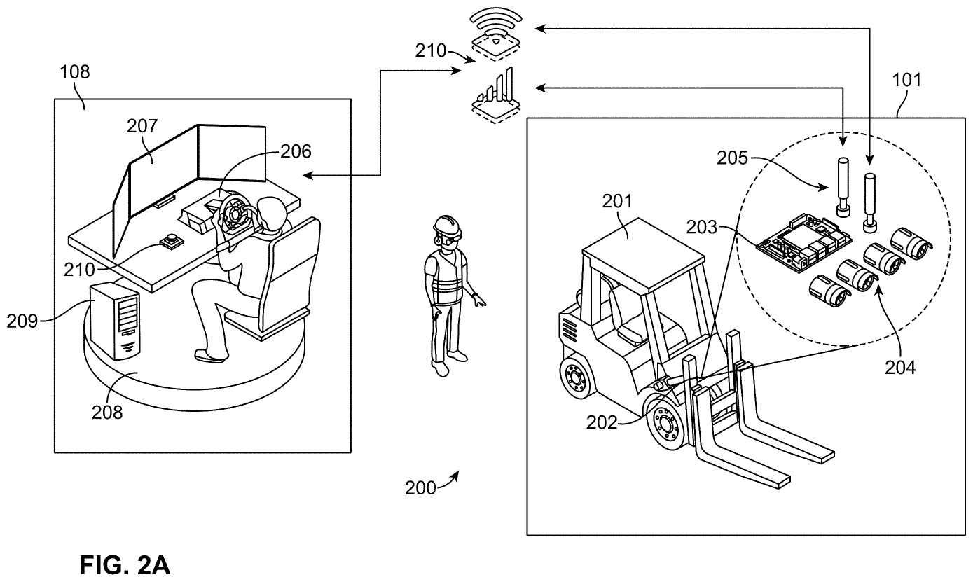

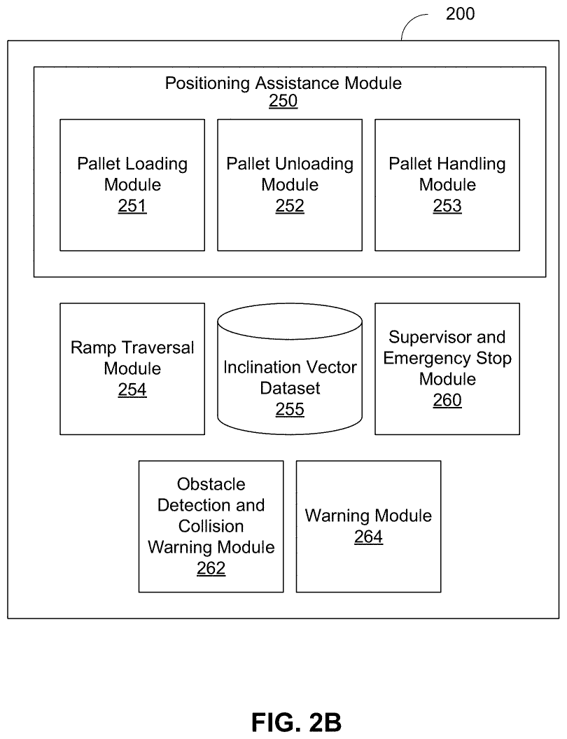

FIG. 2A illustrates an example remote forklift operation system 200, according to one or more embodiments. The remote forklift operation system 200 includes a forklift 101 and an operator station 108. The forklift may in turn include a base vehicle 201, a drive-by-wire system 202, an onboard computing system 203, a sensor suite 204, and a network interface 205 (or a plurality thereof). Moreover, the operator station 108 may in turn a human interface device 206 (or a plurality thereof), a visual display system 207, a computer 208, and a network interface 209 (or a plurality thereof). The network interfaces 205, 209 enable communication between the forklift 101 and the operator station 108 over a private or public digital network 210 (or a plurality thereof).

FIG. 2B illustrates example control modules of the remote forklift operation system 200, in accordance with one or more embodiments. In some embodiments, the control modules of the remote forklift operation system 200 include a positioning assistance module 250, a ramp traversal module 254, an inclination vector dataset 255, a supervisor and emergency stop module 260, an obstacle detection and collision warning module 262, and a warning module 264. In some embodiments, one or more components of the control modules of the remote forklift operation system 200 shown in FIG. 2B are implemented in the on board computing system 203 of the forklift 101. Additionally, in some embodiments, one or more components of the control modules of the remote forklift operation system 200 shown in FIG. 2B are implemented in the computer 208 of the operator station 108.

The positioning assistance module 250 includes a pallet loading module 251, a pallet unloading module 252, and a pallet handling module 254. The pallet loading module 251 is configured to control the forklift 101 to load a pallet onto the fork of the forklift. The pallet unloading module 252 is configured to control the forklift 101 to unload a pallet from the fork of the forklift. Moreover, the pallet handling module 253 is configured to control the forklift 101 to manipulate pallets. A more detailed operation of the positioning assistance module 250 is provided hereinbelow.

The ramp traversal module 254 is configured aid remote drivers to navigate a forklift 101 through inclined surfaces. The ramp traversal module 254 is configured to retrieve incline vector information from the inclination vector dataset 255. The information stored in the inclination vector dataset 255 corresponds to inclination information for the traversable surfaces of a warehouse that had been mapped in advance or during operation of one or more forklifts. A more detailed operation of the ramp traversal model 254 is provided hereinbelow.

The supervisor and emergency stop module 260 is configured to monitor network conditions of the forklift operation system 200 and may control the forklift when the network conditions fall below threshold level. In some embodiments, the supervisor and emergency stop module 260 is configured to stop the operation of a forklift 101 if the network condition of the forklift operation system 200 falls below the threshold level. A more detailed operation of the supervisor and emergency stop module 260 is provided hereinbelow.

The obstacle detection and collision warning module 262 is configured to receive sensor data from one or more sensors of a forklift and detect objects or obstacles based on the received sensor data. In some embodiments, the obstacle detection and collision warning module 262 determines whether an object is within a predetermined distance of the forklift, or whether an object is within a predetermined location with respect to the forklift (e.g., underneath the fork of the forklift). In some embodiments, the obstacle detection and collision warning module 262 is configured to trigger a warning event if an object is detected within a predetermined location with respect to the forklift. For example, the obstacle detection and collision warning module 262 may trigger a collision warning event if an object is detected within a set distance from the forklift within a traversal path of the forklift. In another example, the obstacle detection and collision warning module 262 may trigger a fork collision warning event if an object is detected underneath the fork of the forklift. A more detailed operation of the obstacle detection and collision warning module 262 is provided hereinbelow.

The warning module 264 is configured to control signaling devices embedded in a forklift to warn people around the forklift of one or more actions being performed by the forklift. For example, the warning module 264 may control a set of auditory or visual signaling devices (such as speakers or lights) based on a maneuver being performed by the forklift. A more detailed operation of the warning module 264 is provided hereinbelow.

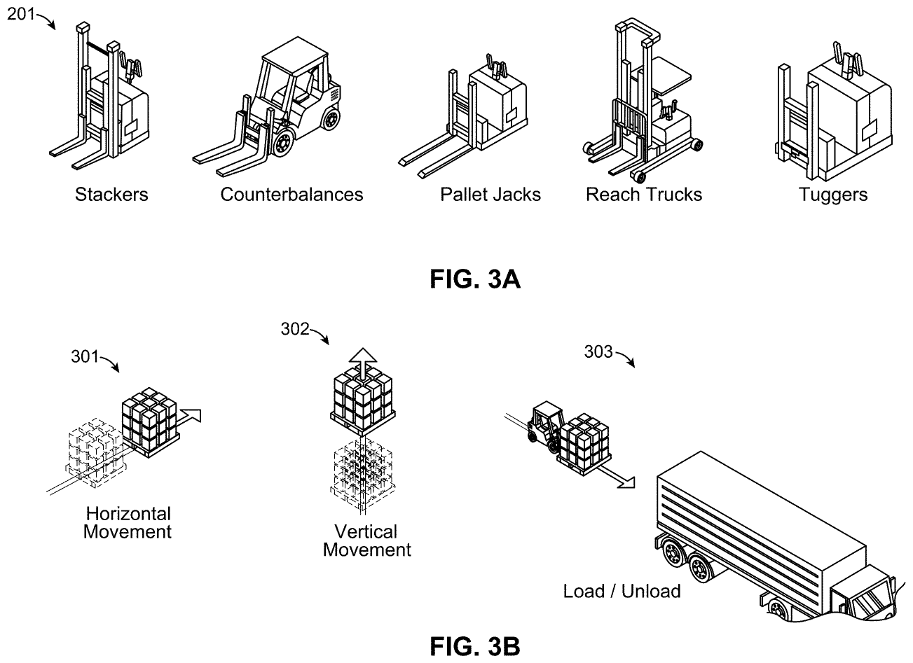

FIG. 3A illustrates various types of forklifts, according to one or more embodiments. FIG. 3B illustrates various transportation modes for forklifts, according to one or more embodiments. As illustrated in FIG. 3A, a forklift may be a stacker, a counterbalance, a pallet jack, a reach truck, a tugger, or other type of forklift or utility vehicle. Moreover, as illustrated in FIG. 3B, modes of pallet transportation performed by a forklift may include horizontal movement 301, vertical movement 302 or load/unload process 303.

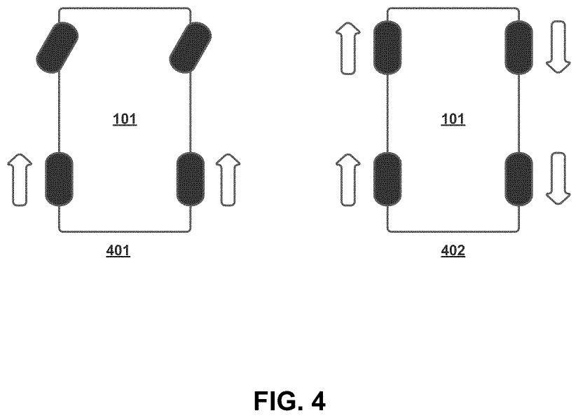

FIG. 4 illustrates various steering methods, according to various embodiments. As illustrated in FIG. 4, the maneuvering mode of a base vehicle 201 may be performed either as a regular steer 401 or tank steer 402. In regular steer 401, the base vehicle 201 may turn by steering a first wheel pair (e.g., front wheels including a front-left wheel and a front-right wheel, or rear wheels including a rear-left wheel and a rear-right wheel) and powering a second wheel pair. In tank steer 402, the base vehicle 201 may turn by powering a first side of both wheel pairs to rotate in one direction and powering a second side of both wheel pairs to rotate in the opposite direction. For example, the base vehicle 201 may turn the front-left wheel and the rear-left wheel in a forward direction, and the front-right wheel and the rear-right wheel in a reverse direction to turn right. Similarly, the base vehicle 201 may turn the front-left wheel and the rear-left wheel in a reverse direction, and the front-right wheel and the rear-right wheel in a forward direction to turn left.

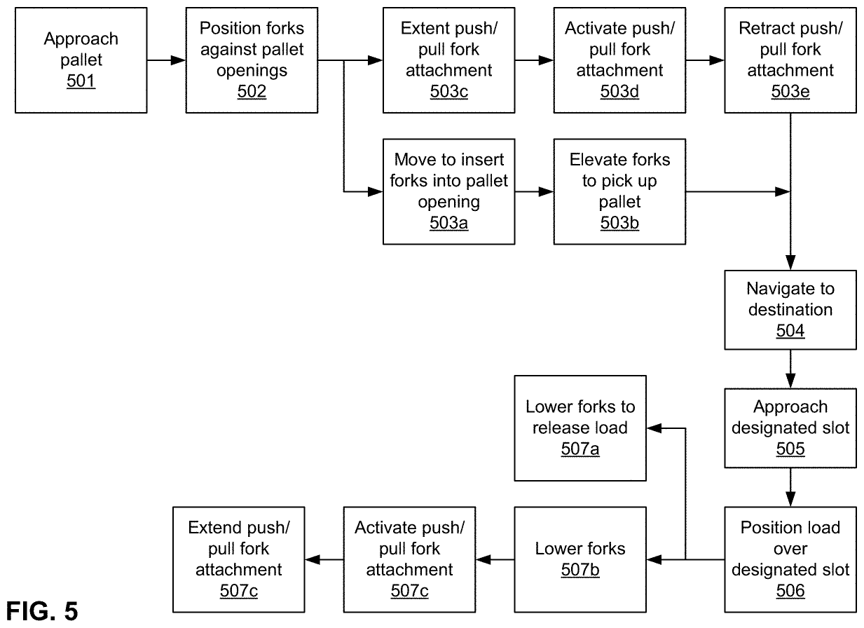

FIG. 5 illustrates a flow diagram of the operation of a forklift, according to one or more embodiments. The forklift may first pick up a pallet. To pick up a pallet, a forklift 201 may approach 501 a pallet located in the point of origin on the warehouse floor or a pallet rack, position 502 the fork against pallet openings. In some embodiments, to pick up the pallet, the forklift 201 moves 503a to insert the fork into the openings and elevates 503c the fork. Alternatively, in other embodiments, to pick up the pallet, the forklift 201 extends 503c a push/pull fork attachment, activates 503d the push/pull fork attachment, and retracts 503e the push/pull fork attachment.

After picking up a pallet, the forklift 201 may navigate 504 to the point of destination, approach 505 the designated slot (e.g., on the floor in the loading zone 102, drop-off zone 103 or a picking area 105, or in a pallet rack 106), and position 506 the load over the designated slot. Moreover, once the pallet is positioned over the designated slot, the forklift 201 drops off the pallet in the designated slot. In some to drop off the pallet in the designated slot, the forklift lowers the fork 507a to release the pallet. Alternatively, in other embodiments, to drop off the pallet in the designated slot, the forklift lowers the fork 507b, activates 507c the push/pull fork attachment, and extends 507d the push/pull fork attachment.

Referring back to FIG. 2A, in an embodiment, a forklift 101 may be connected to the operator station 108 via a flexible network cable as opposed to one or more wireless connections. For example, such an embodiment may be used in situations where only limited mobility of the forklift is required (e.g., its function is to load pallets into trucks via one or more adjacent docks) and where wireless communication channels may be unreliable or undesirable (e.g., due to maintenance of radio silence imposed by regulations or due to high levels of radio noise in the respective bands).

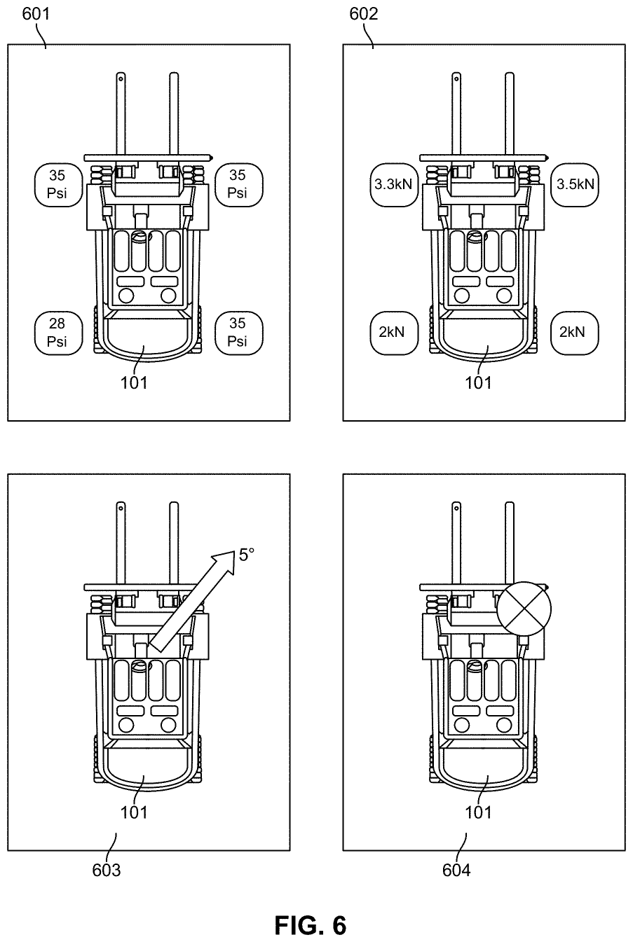

In an embodiment, a visual display system 207 may additionally include a mixed reality layer or a heads-up display, updating and displaying the state of one or more technical parameters of a connected forklift 101 in graphical or numerical form substantially in real time. As an example, illustrated in FIG. 6, a visual display system 207 may include a first indicator 601 showing pneumatic pressure inside individual wheels of a forklift 101, a second indicator 602 showing force experienced by individual suspension hardpoints of a forklift 101, a third indicator 603 showing forklift tilt based on readings of sensors such as gyroscope, accelerometer, magnetometer, or other type of inertial measurement units, or a fourth indicator 604 showing a center of gravity of the forklift 101 (e.g., carrying a load).

In a further embodiment, responsive to an indicator value exceeding a predefined threshold, a visual display system 207 may change the visual representation of the indicators 601, 602 603 604.

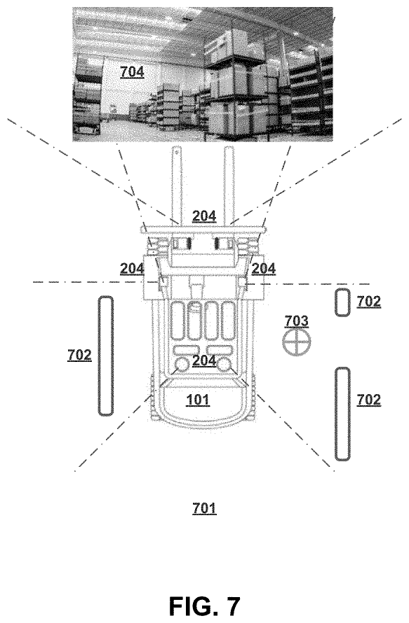

In an embodiment, a visual display system 207 may additionally include an indicator of the available field of view (FoV) of the cameras currently active on the forklift 101. As an example, illustrated in FIG. 7, an FoV indicator 701 may include a schematic top-down representation of the forklift 101 and rays representing the edges of each camera's field of vision.

In a further embodiment, an FoV indicator 701 may additionally display transformed textures of video feeds 704 currently captured by the cameras or symbolic representation of data acquired by other sensors 204, such as obstacles currently detected by ranging sensors 204 represented as solid markers 702, or their historical last seen positions represented as fading out markers 703.

Referring back to FIG. 2A, in an embodiment, the sensor suite 204 may additionally include fork-mounted cameras or proximity sensors such as sonars, enabling the remote operator to assess the potential risk of collision of the vehicle's 101 fork or cargo with adjacent pallets or material on a rack 106, particularly when the fork is elevated or extended.

In a further embodiment, the operator station 108 may additionally include a video focus control. Responsive to manual or programmatic activation of the video focus control, the operator station 108 may enlarge, reposition, highlight, improve or otherwise manipulate one or more video feeds. For example, such an approach may be used to focus the operator's attention on rear camera video feed while backing up, or to focus the operator's attention on a fork-mounted camera video feed responsive to detection of material in a close proximity of a fork.

In a further embodiment, a visual display system 207 may additionally include a fork status indicator. For example, a fork status indicator may display the current status of fork elevation in graphical or numerical form. In a further embodiment, a fork status indicator may display an alarm responsive to an operator driving a forklift 101 for considerable durations of time with a fork extended or elevated above a threshold level, which may constitute a hazard.

### Forklift Pallet Loading Module

The pallet loading module 251 is configured to aid the control of a forklift 101 to load a pallet onto the fork of the forklift. There are a number of challenges in performing this procedure during remote operation of a forklift 101. To load a pallet onto the fork of a forklift, an operator should first accurately position the forklift 101 laterally against pallet openings, and subsequently insert the fork at full length into the pallet openings before elevating the fork and thus lifting the pallet.

In an embodiment, the pallet loading module 251 of the positioning assistance module 250 aids the operator of the forklift to follow a pallet approach trajectory with a regular steer or a tank steer forklift 101. In an example embodiment, the pallet loading module 251 may use a manual input method or a programmatic interface to enable the operator or warehouse automation respectively to identify the target pallet, a computer vision (CV) component to identify the pallet openings and determine the distance of the pallet relative to the vehicle, and a mixed reality indicator (such as a representation of estimated left and right wheel tracks computed under the assumption that the current translational and rotational velocity or acceleration of the vehicle will be maintained) in the visual display system 207. In another embodiment, the remote forklift operation system 200 may additionally include time-of-flight ranging sensors 204 such as pulse or continuous-wave LIDAR, radar, or sonar to enhance the accuracy of the solution.

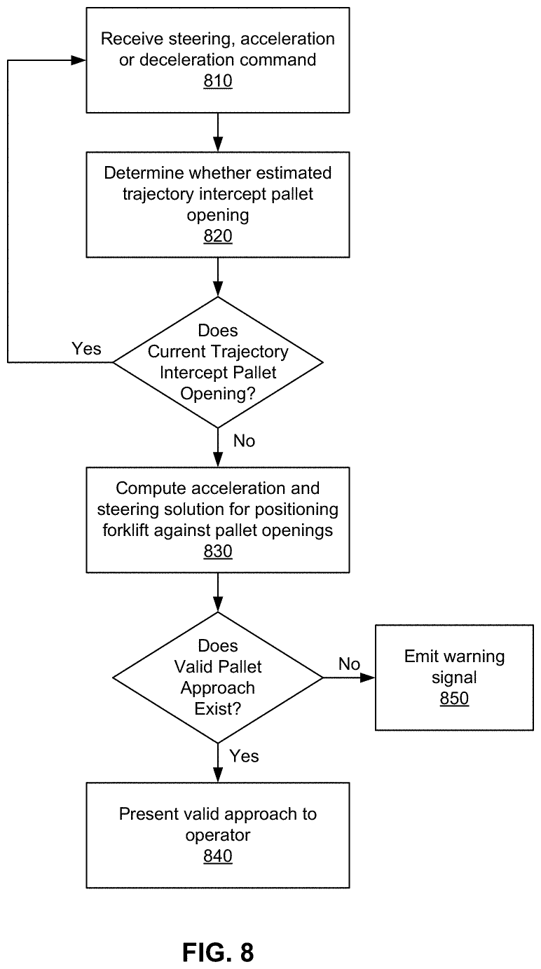

FIG. 8 illustrates a flow diagram for controlling a forklift to load a pallet onto the fork of the forklift, according to one or more embodiments. The remote forklift operation system 200 receives 810 steering, acceleration, or deceleration commands from an operator of the forklift. Responsive to the operator issuing steering, acceleration or deceleration commands the pallet loading module 251 of the positioning assistance module 250 determines 820 the estimated vehicle trajectory and its representation in the respective mixed reality indicator. Responsive to the pallet loading module 251 determining that the estimated vehicle trajectory does not intercept the pallet opening plane in the optimal location, the pallet loading module 251 computes 830 an acceleration and steering solution that would position the vehicle against pallet openings, and presents 840 operational recommendations on a mixed reality indicator in numerical or graphical form, or provides HID tactile feedback, auditory feedback or other kind of feedback to the operator. In a further embodiment, responsive to the pallet loading module 251 determining that no safe pallet approach solution exists, the positioning assistance module emits 850 a visual, auditory, or other type of warning signal.

In an embodiment, a forklift 101 additionally includes one or more flashlight, LED, or other non-coherent light source to illuminate the pallet openings.

In an embodiment, a forklift 101 additionally includes one or more optical wavelength lasers axially aligned with the fork. Illumination provided by such a laser serves to improve an operator's sense of perspective.

In an embodiment, a forklift 101 additionally includes one or more cameras positioned at fork tips or elsewhere on the fork or alongside it.

In an embodiment, a forklift 101 additionally includes one or more structured light or time of flight sensors 204 aligned with the fork, and the visual display system 207 additionally includes fork guidance mixed reality elements or auditory guidance. Responsive to acquisition of measurements by the structured light or time of flight sensors 204, the visual display system 207 renders or adjusts a mixed reality element or a plurality thereof describing the true geometry of the pallet opening, its position relative to the fork, and any potential obstacles inside, or produces auditory guidance signals.

In a further embodiment, an operator station 108 may additionally include a human interface device (HID) or mixed reality controls to switch on/off the pallet opening illumination devices described hereinabove, or manipulate their brightness or power level.

In a further embodiment, a forklift 101 may additionally include automation to switch on/off the pallet opening illumination devices described hereinabove according to predefined rules. For example, a forklift 101 may automatically switch on laser fork guidance responsive to the pallet loading module 251 producing confirmation that the forklift 101 is on a valid approach trajectory to a target pallet.

In an embodiment, the sensor suite 204 additionally includes a ranging device (such as an ultrasonic sonar or a stereo camera) or a plurality thereof mounted on the fork (for example, at its base and along its axis), and the visual display system 207 additionally includes a guidance element or a plurality thereof (for example, a series of lit or unlit circles, each representing a ranging device). At different fork insertion depths different subsets of ranging devices would be observing short distances to the proximal obstacle. Responsive to changes in the active ranging device subset the visual display system changes the representation of the respective ranging device.

In a further embodiment, the operator station 108 may additionally produce a visual or auditory signal responsive to activation of the full set of ranging devices.

### Forklift Pallet Unloading Module

The pallet unloading module 252 is configured to aid the control of a forklift 101 to unload a pallet from the fork of the forklift. There are a number of challenges in performing this procedure during remote operation of a forklift 101. When unloading a pallet, the fork must be lowered sufficiently to completely lose contact with the pallet at its top surface but not yet come into contact with the pallet at its bottom surface before considering the pallet released and moving away from it.

In an embodiment, the sensor suite 204 may additionally include one or more proximity sensor pairs installed on top and bottom surfaces of the fork. Average, minimum or other aggregate distances measured by the top sensor and the bottom sensor are referred to as D_{T} and D_{B}, respectively.

In a further embodiment, responsive to both D_{T}and D_{B}values exceeding a predefined threshold the pallet unloading module 251 determines that the fork is disengaged from the pallet.

In another embodiment, the pallet unloading module 251 monitors D_{T} and D_{B} values in substantial real-time. Responsive to the product P(t)=D_{T}(t)·D_{B}(t) reaching a peak value during fork lowering process and starting to diminish, or the derivative of P(t) or approaching or becoming zero, the pallet unloading module 251 determines that the fork is disengaged from the pallet. Such an embodiment allows to attain the optimal distance from both the bottom and the top of the pallet opening.

In another embodiment, the sensor suite 204 may additionally include one or more optical wavelength lasers or directional lights with a known beam cone angle axially aligned with the fork and positioned above and below of the fork surfaces, and the pallet unloading module 251 may additionally include a CV module to determine the distance to the light spots generated by the light sources. Responsive to the pallet unloading module 251 determining that distances to all light spots exceed a predefined threshold, the pallet unloading module 251 determines that the fork is disengaged from the pallet.

In another embodiment, the sensor suite 204 may additionally include one or more pressure sensors such as piezometers, pressure switches, capacitive, electromagnetic, or other pressure sensors installed on top and bottom surfaces of the fork. Responsive to all or a threshold number of pressure sensors reporting pressure levels below a predefined threshold, the pallet unloading module 251 determines that the fork is disengaged from the pallet.

In another embodiment, the forklift 101 may additionally include one or more conductive spring-mounted motile extruding elements installed on the top and bottom surfaces of the fork and capable of sinking into the surface of the fork under pressure, thereby closing an electrical circuit, or popping out under the influence of springs and opening an electrical circuit, or vice-versa. Responsive to respective inputs of the pallet unloading module 252 indicating that all or a threshold number of electrical circuits is in the state corresponding to spring-elevated extruding state of the motile elements, the pallet unloading module 251 determines that the fork is disengaged from the pallet.

In another embodiment, the sensor suite 204 may additionally include one or more acoustic generator and sensor pairs installed on the top and bottom surfaces of the fork. Since the speed of sound in solid continuous mediums is generally, and in wood in particular is 10× that of the speed of sound in the air, it is possible to distinguish between presence or absence of contact between a sensor and a generator by emitting a sound pulse at the generator and measuring the different times of arrival of the pulse to the sensor. Responsive to the pallet unloading module 252 detecting times of arrival corresponding only to aerial transmission or transmission in the fork material, and absence of a pulse time of arrival corresponding to the wooden or plastic material of the pallet, the pallet unloading module 251 determines that the fork is disengaged from the pallet.

In another embodiment, the sensor suite 204 may additionally include one or more dielectric permittivity measurement devices at ISM (2.4 GHz) frequencies or other frequencies installed on the top and bottom surfaces of the fork. Responsive to the dielectric permittivity profiles measured mismatching to the profile of wooden or plastic material of the pallet, the pallet unloading module 251 determines that the fork is disengaged from the pallet.

### Forklift Pallet Handling Module

The pallet handling module 253 is configured to aid the control of a forklift 101 to manipulate pallets or cargo on rack shelves. The pallets or cargo on rack shelves may be located at different heights and may not be well observable by an operator via the cameras, thus making it challenging to perform vertical fork movement precisely.

In an embodiment, the sensor suite 204 additionally includes a camera with a high vertical FoV (high-VFoV). For example, such a camera may be installed on the average expected height of rack shelves in the warehouse 100. In a further embodiment, the operator station 108 may perform conversion of the high-VFoV camera video feed to rectilinear projection and truncation of the video feed corners so that the resulting video feed is rectangular.

In an embodiment, a forklift 101 additionally includes one or more cameras positioned at fork tips or elsewhere on the fork or alongside it.

In an embodiment, a forklift 101 additionally includes an extensible mechanical arm with one or more degrees of freedom and one or more cameras positioned at the arm tip or elsewhere on the fork or alongside the fork, and the operator station 108 additionally includes manual or automatic controls to position the mechanical arm against the required shelf.

In an embodiment, a forklift 101 additionally includes a detachable aerial drone and one or more cameras located on the drone, and the operator station 108 additionally includes manual or automatic controls to position the drone against the required shelf.

In an embodiment, a forklift 101 additionally includes multiple cameras positioned at different heights, each corresponding to an expected height of a rack shelf in the warehouse 100.

In an embodiment, the warehouse 100 additionally includes static or motile cameras positioned against rack shelves, and the operator station 108 additionally includes manual or automatic controls to select and display video feeds from the warehouse cameras on the visual display system 207.

### Forklift Ramp Traversal Module

The ramp traversal module 254 is configured aid remote drivers to navigate a forklift 101 through inclined surfaces. In an embodiment, rem ramp traversal module 254 may serve at least two purposes: enabling the remote operator to assess the incline correctly and safely driving on narrow ramps.

In one embodiment, a visual display system 207 may additionally include a floor incline indicator and the sensor suite 204 may additionally include a gyroscope, accelerometer, magnetometer, or other type of inertial measurement unit (IMU). Responsive to acquisition of measurements by an IMU onboard a forklift 101, the onboard computer 203 transmits the measurements via one or more wireless networks 210 to the operator station 108. Responsive to receival of IMU measurements by the computer 208 the ramp traversal module 254 may update the floor incline indicator in the visual display system 207 (e.g., displayed in numerical or graphical form).

In another embodiment, remote forklift operation system 200 may additionally include a floor inclination vector dataset 255 mapped in advance or during operations and stored in a respective database accessible to a computer 208, and the sensor suite 204 may additionally include an in-doors positioning system based on wireless triangulation, computer vision, or other techniques. Responsive to acquisition of measurements by a positioning system, the onboard computer 203 transmits the measurements via one or more wireless networks 210 to the operator station 108. Responsive to receival of positioning system measurements the computer 208 extracts the value from the floor inclination vector dataset 255 corresponding to the measurements, and responsive to successful extraction the ramp traversal module 254 may update the floor incline indicator in the visual display system 207.

In one embodiment, the sensor suite 204 may additionally include one or more high-FoV cameras mounted near the base of the forklift and centered along the axis of translational motion of the forklift.

In another embodiment, the sensor suite 204 may additionally include two or more cameras mounted in close proximity to wheels or vehicle 201 components protruding laterally from the vehicle 201 at maximum distance.

In an embodiment, remote forklift operation system 200 may additionally include a navigation module to enable the operator to navigate the warehouse 100 facility efficiently. In this embodiment, the sensor suite 204 may additionally include an in-doors positioning system based on wireless triangulation (involving spatially distributed radio modules such as BLE beacons or WiFi hotspots), computer vision techniques (involving spatially distributed tags such as barcode, QR code, or ArUco markers), or other techniques; the visual display system 207 may additionally include a 2D or 3D minimap representation of the warehouse 100, which may be optionally centered on the position of the forklift 101 in substantial real time, as well as auditory or mixed reality guidelines.

### Forklift Supervisor and Emergency Stop Module

In an embodiment, remote forklift operation system 200 may additionally include a supervisor and emergency stop module 260 to improve safety in unstable wireless network 210 conditions.

In one embodiment, the operator station 108 additionally includes an emergency stop button 210. Responsive to manual activation of the emergency stop button 210 the operator station triggers an E-STOP event at the operator station 108 with subsequent transmission to the forklift 101.

In another embodiment, the supervisor and emergency stop module 260 monitors telemetry and command & control channel latencies at both the operator station 108 and forklift 101. Responsive to either of the latency values exceeding a predefined threshold, the supervisor and emergency stop module 260 triggers an E-STOP event directly at the forklift 101 or at the operator station 108 with subsequent transmission to the forklift 101.

In another embodiment, the supervisor and emergency stop module 260 monitors latencies and synchronization of video feeds acquired by the sensor suite 204. Responsive to detection of latency levels exceeding a predefined threshold, or to detection of maximum desynchronization interval between any pair of video feeds exceeding a predefined threshold, the supervisor and emergency stop module 260 triggers an E-STOP event at the operator station 108 with subsequent transmission to the forklift 101. In some embodiments, an origin time identification for each video feed frame is used for identifying a desynchronization interval between pairs of video feeds. For example, the video frame format may partially include encoding timestamp at the computer 203, or a sequentially growing numerical identifier (individual for each video feed or common for two or more of them to enable the operator station 108 to perform faster desynchronization tests) tracked at the computer 203. The identification may include a metadata field, or a portion of a video frame in numerical format, QR code format, or other kind of visually representable machine-readable format.

In a further embodiment, the supervisor and emergency stop module 260 monitors last-seen video feed IDs as a source of a regular keep-alive signal. Responsive to detection of the number of consecutive missing keep-alive signals in a video feed exceeding a predefined threshold, the supervisor and emergency stop module 260 triggers an E-STOP event at the operator station 108 with subsequent transmission to the forklift 101, or marks the respective video feed offline and disables its rendering in the video display system 207. Responsive to the total number of disabled video feeds exceeding a predefined threshold, the supervisor and emergency stop module 260 triggers an E-STOP event at the operator station 108 with subsequent transmission to the forklift 101.

In another embodiment, the supervisor and emergency stop module 260 monitors the quality of service of the wireless networks 210 and stores a predefined E-STOP trigger ruleset. The ruleset may include an analytical expression or a fuzzy logic controller such as a trained neural network. The supervisor and emergency stop module 260 queries the ruleset periodically, episodically or in substantially real-time, and applies to it one or more data points describing the current and/or recent state of the wireless networks 210. Responsive to the ruleset returning a hazard estimation value exceeding a predefined threshold, the supervisor and emergency stop module 260 triggers an E-STOP event at the forklift 101.

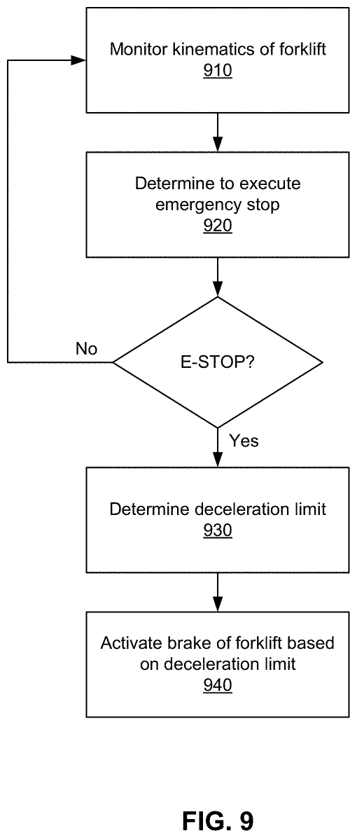

FIG. 9 illustrates a flow diagram for controlling an emergency stop of a forklift, according to one or more embodiments. In certain scenarios, a complete and abrupt halt of a forklift 101 under load is not acceptable, as it may cause the forklift 101 to lose stability and tip over. Similarly, some maneuvers may lead to loss of dynamic stability and cause accidents.

In an embodiment, the supervisor and emergency stop module 260 monitors 910 the kinematics of the forklift 101 accounting for the cargo mass and distribution, extension, and elevation of the fork. The supervisor and emergency stop module 260 then determines 920 whether to execute an emergency stop (e.g., based on the receipt of an E-STOP instruction or based on the triggering of an E-STOP event). Responsive to determining to execute an emergency stop, the supervisor and emergency stop module 260 solves the kinematical equation system to determine 930 a deceleration limit (e.g., based on the maximum safe deceleration) and activates 940 emergency braking according to the solution.

In a further embodiment, the supervisor and emergency stop module 260 maintains an up-to-date emergency braking solution by solving the kinematical equation system periodically, episodically or in substantial real-time. Responsive to determining to execute an emergency stop, the supervisor and emergency stop module 260 activates 940 emergency braking according to the most recent solution.

In a further embodiment, the supervisor and emergency stop module 260 imposes restrictions on maneuverability or velocity of the forklift 101 such that a safe emergency braking procedure would comply with a set of predefined requirements such as total duration or braking distance should the E-STOP event be triggered at any given moment, and ignores or mediates operator commands which would cause the forklift 101 to violate the imposed restrictions.

### Forklift Obstacle Detection and Collision Warning Module

In an embodiment, the sensors 204 of the forklift 101 additionally includes proximity sensors such as sonars to perform obstacle detection along its main movement axis. Responsive to a proximity sensor detecting an obstacle at a distance lower than a predefined threshold, the obstacle detection and collision warning module 262 may trigger a collision warning event. In a further embodiment, the collision warning event may partially include information on the estimated distance to the obstacle. For example, such an embodiment may be useful in preventing forklift collision with a rack while backing up with a pallet on an elevated fork.

In some scenarios it is possible for on-site personnel to be located or passing beneath an elevated fork. In one embodiment, the sensors 204 of the forklift 101 additionally includes downward-facing proximity sensors such as sonars to perform obstacle detection along the movement axis of the fork. Responsive to a proximity sensor detecting an obstacle underneath the fork of the forklift 101 at a distance lower than the estimated height of the fork, the obstacle detection and collision warning module 262 may trigger a fork collision warning event.

In one embodiment, the sensors 204 of the forklift 101 additionally includes downward-facing infrared sensors. Responsive to an infrared sensor detecting an object having temperatures approximately corresponding to human body temperature underneath the fork of the forklift 101, and occupying a sensor area exceeding a predefined threshold, the obstacle detection and collision warning module 262 may trigger a fork collision warning event.

In another embodiment, the sensors 204 of the forklift 101 additionally includes a downward-facing sensor such as an optical camera, time of flight scanner or a structured light scanner, and the obstacle detection and collision warning module 262 may additionally include a CV component trained to detect obstacles such as humans or cargo pallets in the images produced by such a sensor. Responsive to the CV component of the obstacle detection and collision warning module 262 or other fuzzy logic component detecting beneath the fork a matching obstacle profile with a probability above a threshold level, the obstacle detection and collision warning module 262 may trigger a fork collision warning event.

### Forklift Warning System

In an embodiment, the forklift 101 additionally includes an auditory or a visual signaling device mounted on the fork. Responsive to events such as fork collision warning or fork lowering start the signaling device may emit an auditory or a visual warning signal to warn on-site personnel.

In an embodiment, the operator station 108 additionally includes visual or auditory alert systems. Responsive to a fork collision warning event or forklift collision warning event the warning module 264 activates an appropriate alert mechanism of the operator station 108. For example, the operator station 108 may emit regular tone beeps responsive to receiving a stream of forklift collision warning events, with the pitch of beeps corresponding to the estimated distance to the obstacle.

In a further embodiment, the warning module 264 uses separate warning profiles for driving and loading/unloading operations. For example, distances at which a pallet may be considered a collision threat during a loading/unloading operation may be substantially lower than during driving.

In a further embodiment the warning module 264 additionally uses kinematic-based warning profiles, with collision threat estimates expressed as a function of vehicle speed, operational latency, or other parameters.

Moreover, to reduce the risk of accidents, it may be desirable to enable on-site personnel to recognize the direction of the remote operator's attention and focus, which may be challenging due to the absence of the operator and thus familiar visual cues in the forklift cockpit.

In an embodiment, the forklift 101 additionally includes warning lights (e.g., white and red lights) on major surfaces corresponding to possible travel directions or remote operator attention focus directions. For example, the warning module 264 may switch on only white lights on the surface corresponding to the current direction of the operator's focus, and switch on only red lights on all the other surfaces.

In an embodiment, the forklift 101 additionally includes monitors such as E-ink screens or LCD displays on major surfaces corresponding to possible travel directions or remote operator attention focus directions. For example, the warning module 264 may display icons of a face, eyes, or a video feed of the operator's face on monitors on the surface corresponding to the current direction of the operator's focus, and other visual signals on monitors on all the other surfaces.

In an embodiment, the forklift 101 additionally includes lasers or other directional optical beam emitters to highlight on the warehouse 100 floor the current central FoV of the operator. In a further embodiment, the forklift 101 additionally includes one or more optical systems to disperse the highlight over the whole angle of the current central FoV of the operator.

### Additional Control Modules

In some scenarios it is possible for the illumination levels to differ significantly. For instance, a forklift may be required to leave the warehouse into a sunlit territory, and enter an unlit trailer. Such rapid and drastic changes in ambient lighting may lead to temporary blinding of a camera until the high dynamic range software or exposure and sensitivity controller adapts to the changes. To mitigate this, the remote forklift operation system 200 may additionally include a system enabling the forklift 101 to manipulate camera exposure or HDR settings in substantial real time.

In an embodiment, the remote forklift operation system 200 (e.g., at the onboard computer 203) may additionally include an illumination level prediction model based on a pre-mapped dataset, and the sensor suite 204 may additionally include an in-doors positioning system based on wireless triangulation, computer vision, or other techniques. Responsive to the remote forklift operation system 200 predicting the illumination level incompatible with current camera sensitivity, exposure or HDR settings the remote forklift operation system 200 modifies the settings to be compatible with predicted illumination levels (for example, following a linear, logistic, or other function).

In an embodiment, the remote forklift operation system 200 may additionally include an illumination level prediction model based on feedback obtained from the sensor suite 204 and a predefined analytical or fuzzy logic model. The remote forklift operation system 200 invokes the model episodically, periodically or in substantial real time and passes into it a chosen set of current or historical measurements acquired by the sensor suite 204. Responsive to the model on the remote forklift operation system 200 predicting the illumination level incompatible with current camera sensitivity, exposure or HDR settings the remote forklift operation system 200 modifies the settings to be compatible with predicted illumination levels (for example, following a linear, logistic, or other function).

In another embodiment, responsive to illumination change anticipated according to embodiments presented hereinabove, the remote forklift operation system 200 may enforce a gradual change of camera sensitivity, exposure or HDR settings by explicitly manipulating ambient lighting level reaching the camera. For example, the remote forklift operation system 200 may temporarily switch on/off or modify the brightness of an onboard light source mounted on the forklift 101 in the view of a camera, or a static light source elsewhere in the warehouse facility 100 in the current view of a camera. For example, such an embodiment may be used in scenarios where explicit manipulation of camera settings is not feasible or not practical.

In another embodiment, responsive to illumination change anticipated according to embodiments presented hereinabove, the remote forklift operation system 200 may switch video feeds between adjacent cameras with different sensitivity, exposure or HDR settings. For example, such an embodiment may be used in scenarios where explicit manipulation of camera settings is not feasible or not practical.

In another embodiment, responsive to illumination change anticipated according to embodiments presented hereinabove, the operator station 107 may generate an audible warning or a mixed reality element on the visual display system 207 instructing the operator to exercise caution or to execute specific actions such as halt the forklift 101 or to reduce velocity to a predetermined value in order to allow the cameras sufficient time to adapt and change sensitivity, exposure or HDR settings.

In an embodiment, the remote operation system 200 partially includes a wireless connectivity model (WCM). The WCM is built on a dataset that is either pre-mapped or updated episodically, periodically or in substantial real time by the forklifts 101 or other utility vehicles. For example, the model may be based on input features such as positions and velocities of all vehicles 201 in the warehouse 100, geometry and loadout of pallet racks 106, or locations of wireless network access points 210. Responsive to the current state of the features the remote operation system 200 recomputes the predicted throughput for a forklift 101 and makes this information available to the forklift 101 safety system, the 108 operator station, or other consumers. In a further embodiment, the remote operation system 200 may additionally issue notifications to one or more consumers about new predictions being available, or about new predictions possessing characteristics of an unsafe teleoperation environment.

### Additional Considerations

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of embodiments. This description should be read to include one or at least one and the singular also includes the plural unless it is obvious that it is meant otherwise. The use of the term and/or is intended to mean any of: “both”, “and”, or “or.”’

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments.

What is claimed is:

1. A method for autonomously operating a forklift, the method comprising:
determining a mass distribution of a load being carried by the forklift;
monitoring the kinematics of the forklift based at least in part on a mass distribution of a load being carried by the forklift and an elevation of a fork of the forklift;
determining to execute an emergency stop;
responsive to determining to execute the emergency stop, determining a deceleration limit for the forklift based on the kinematics of the forklift; and
activating a brake of the forklift based on the determined deceleration limit.

2. The method of claim 1, wherein determining to execute the emergency stop comprises receiving an emergency stop message from a remote operator of the forklift.

3. The method of claim 1, wherein determining to execute the emergency stop comprises:
receiving one or more video feeds captured by one or more cameras of the forklift;
determining a latency of the one or more video feeds; and
responsive to determining that the latency of the one or more video feeds exceed a threshold latency, determining to execute the emergency stop.

4. The method of claim 3, wherein determining to execute the emergency stop further comprises:
determining a desynchronization interval between pairs of video feeds; and
responsive to determining that the desynchronization interval between pairs of video feeds exceeds a threshold desynchronization threshold, determining to execute the emergency stop.

5. The method of claim 1, wherein determining to execute the emergency stop comprises receiving an emergency stop instruction from a supervisor system in response to the supervisor system failing to receive a threshold number of keep-alive signals.

6. The method of claim 1, wherein monitoring the kinematics of the forklift comprises periodically solving a kinematics equation based on the mass distribution of the load being carried by the forklift and the elevation of the fork of the forklift.

7. The method of claim 6, wherein determining a deceleration limit for the forklift based on the kinematics of the forklift comprises retrieving a latest solution of the kinematics equation and determining the deceleration limit based on the retrieved latest solution of the kinematics equation.

8. The method of claim 1, wherein the mass distribution of the load being carried by the forklift is determined using at least one of a set of load sensors embedded in the fork for the forklift, and a set of pressure sensors embedded in a set of wheels of the forklift.

9. The method of claim 1, further comprising:
analyzing one or more sensors embedded in the forklift;
determining whether an object is within a location determined based on at least one of a location of the forklift and the elevation of the fork of the forklift; and
responsive to detecting an object within the location determined based on at least one of the location of the forklift and the elevation of the fork of the forklift, triggering a collision warning event.

10. The method of claim 9, wherein the one or more sensors include a proximity sensor and wherein determining whether an object is within a location determined based on at least one of a location of the forklift and the elevation of the fork of the forklift comprises determining, based on an output of the proximity sensor, whether an object is within a threshold distance from the forklift.

11. The method of claim 9, wherein the one or more sensors include a sensor for detecting objects along a movement axis of the fork of the forklift, and wherein determining whether an object is within a location determined based on at least one of a location of the forklift and the elevation of the fork of the forklift comprises determining, based on an output of sensor for detecting objects along a movement axis of the fork of the forklift, whether an object is underneath the fork of the forklift.

12. The method of claim 11, wherein the sensor for detecting objects along a movement axis of the fork of the forklift is one of a downward-facing proximity sensor, a downward-facing infrared sensor, a downward-facing camera, a downward-facing time of flight scanner, and a downward-facing structured light scanner.

13. The method of claim 11, wherein determining, based on an output of sensor for detecting objects along a movement axis of the fork of the forklift, whether an object is underneath the fork of the forklift comprises detecting an object inside the movement axis of the fork of the forklift at a height lower than an estimated height of the fork of the forklift.

14. The method of claim 11, wherein the collision warning event is triggered responsive to determining that the detected object has a temperature within a predetermined temperature range.

15. The method of claim 14, wherein the predetermined temperature range is set based on a typical temperature of a human body.

16. A forklift comprising:
a fork for handling pallets holding a load;
a set of sensors comprising a set of load sensors for determining a mass distribution of the load being carried by the forklift; and
an emergency stop module configured to monitor the kinematics of the forklift based at least in part on a mass distribution of the load being carried by the forklift and an elevation of the fork of the forklift, and responsive to determining to execute an emergency stop, determine a deceleration limit for the forklift based on the kinematics of the forklift and activate a brake of the forklift based on the determined deceleration limit.

17. The forklift of claim 16, wherein the emergency stop module determines to execute the emergency stop based at least on one of a latency of one or more video feeds captured by cameras of the forklift, and a desynchronization interval between pairs of video feeds captured by cameras of the forklift.

18. The forklift of claim 16, further comprising:
a collision warning module configured to trigger a collision warning event in response to determining that an object is within a location determined based on at least one of a location of the forklift and the elevation of the fork of the forklift.

19. A non-transitory computer-readable storage medium storing instructions for controlling a forklift, the instructions when executed by a processor cause the processor to:
determine a mass distribution of a load being carried by the forklift;
monitor the kinematics of the forklift based at least in part on the mass distribution of a load being carried by the forklift and an elevation of a fork of the forklift;
determine to execute an emergency stop;
responsive to determining to execute the emergency stop, determine a deceleration limit for the forklift based on the kinematics of the forklift; and
activate a brake of the forklift based on the determined deceleration limit.

20. The non-transitory computer-readable storage medium of claim 19, wherein the instructions further cause the processor to:
analyze one or more sensors embedded in the forklift;
determine whether an object is within a location determined based on at least one of a location of the forklift and the elevation of the fork of the forklift; and
responsive to detecting an object within the location determined based on at least one of the location of the forklift and the elevation of the fork of the forklift, trigger a collision warning event.
